(19) United States
(12) Patent Application Publication
(10) Pub. No.: US 2003/0184794 A1
(43) Pub. Date: Oct. 2, 2003

(54) System and method for supporting network devices

(76) Inventors: Gary Stringham, Boise, ID (US); Todd A. Lutz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/106,713

(22) Filed: Mar. 26, 2002

(51) Int. Cl. G06F 15/00; G06F 15/177; G06F 13/00; G06F 3/12

(52) U.S. Cl. 358/1.15; 709/222; 717/176

(57) ABSTRACT

The present disclosure relates to a system and method for supporting a network device. In one arrangement, the system and method pertain to establishing a network connection, communicating with a code source via the network, downloading operating code from the code source via the network, and booting using the downloaded operating code. In another arrangement, the system and method pertain to receiving a communication from the network device requesting operating code, determining which operating code to provide to the network device, and downloading operating code to the network device via the network.

### FIELD OF THE INVENTION

The present disclosure relates to a system and method for supporting network devices. More particularly, the disclosure relates to a system and method with which network devices, such as network printers, can obtain operating code.

### BACKGROUND OF THE INVENTION

Nearly every network device requires basic operating code to accomplish its intended functionalities. Network printers, for example, normally include a rudimentary operating system (O/S) that controls all printer functions including translating data received from other devices, rasterizing data, operating the print engine, etc. Normally, the basic operating code is stored in read only memory (ROM) or hard disk of the network device and portions of the code are brought into random access memory (RAM) when those portions are to be executed.

Although such arrangements function adequately well, they do pose some disadvantages. For one, where the operating code is stored in ROM, the cost of the device is increased in that ROM elements are relatively expensive. Second, in that the operating code is stored locally in the device, updating of the code requires manual downloading of new versions code for each network device separately. Where many such network devices are used on a particular network, for instance in an office local area network (LAN), this manual downloading of each device can be tedious and inefficient.

From the above, it can be appreciated that it would be desirable to have a system and method in which a network device, such as a network printer, can obtain the code it needs to operate from an independent source such that the above-noted problems can be avoided.

### SUMMARY OF THE INVENTION

The present disclosure relates to a system and method for supporting a network device. In one arrangement, the system and method pertain to establishing a network connection, communicating with a code source via the network, downloading operating code from the code source via the network, and booting using the downloaded operating code.

In another arrangement, the system and method pertain to receiving a communication from the network device requesting operating code, determining which operating code to provide to the network device, and downloading operating code to the network device via the network.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of a system for providing operating code to a network device.

FIG. 2 is a schematic view of a network-based system for providing operating code to network printers.

FIG. 3 is a schematic view of a network printer shown in FIG. 2.

FIG. 4 is a schematic view of a network server shown in FIG. 2.

FIG. 5 is a flow diagram that provides an example of operation of the system of FIG. 2.

FIG. 6 is a flow diagram that provides an example operation of the base code of the network printer shown in FIG. 3.

FIG. 7 is a flow diagram that provides an example of operation of the code distributor of the network server shown in FIG. 4.

### DETAILED DESCRIPTION

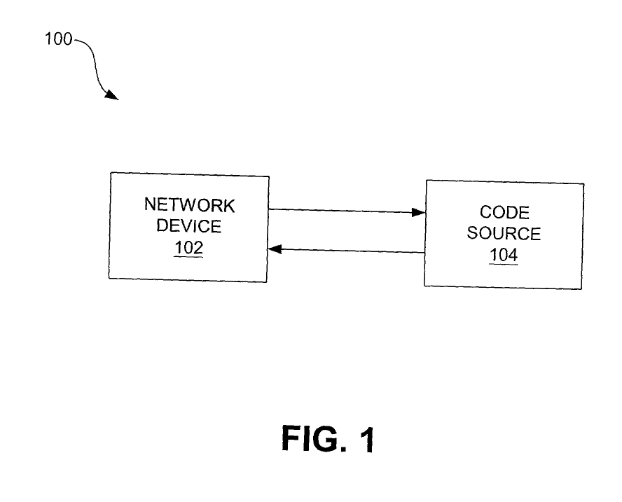

Referring now in more detail to the drawings, in which like numerals indicate corresponding parts throughout the several views, FIG. 1 illustrates a generalized system 100 for providing operating code to a network device. As indicated in this figure, the system 100 generally comprises a network device 102 and a code source. 104. As will be appreciated by persons having ordinary skill in the art, the network device 102 can comprise substantially any device that is capable of sending and/or receiving information over a network. By way of example, the network device 102 can comprise a so-called peripheral device such as a printer, copier, facsimile machine, scanner, etc., or a network appliance that comprises an embedded computer.

Irrespective of its specific configuration, the network device 102 generally comprises enough code to communicate with the code source 104. For instance, the network device 102 has the code it needs to establish a network connection such that it can communicate with the code source 104 via a network. As with the network device 102, the code source 104 is capable of several different configurations. By way of example, the code source can comprise a server, personal computer, or other computing device capable of storing data and providing it to the network device 102.

In operation, the network device 102 can boot with the aid of the code source 104. For instance, when the network device 102 is powered, it establishes a network connection and, thereby, establishes communications with the code source 104. Once communications have been established, the network device 102 requests operating code from the code source 104 and then receives the necessary operating code from the code source such that the booting process can be completed. Once the operating code has been received, the network device 102 can be operated to provide its intended functionality (e.g., printing, copying, etc.) in similar manner to conventional network devices.

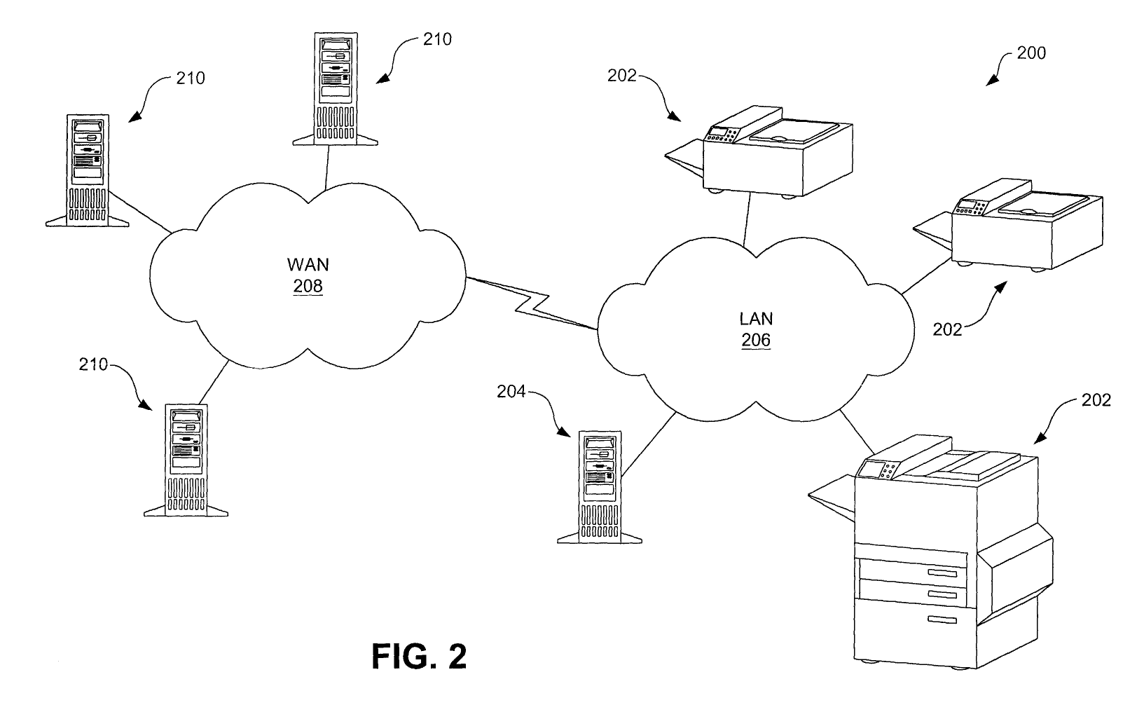

FIG. 2 illustrates a network-based system 200 in which operating code can be provided to a network device with a code source. More particularly, FIG. 2 illustrates a system 200 in which one or more network printers can obtain operating code from one or more different servers via one or more networks. Although network printers and network servers are explicitly discussed in relation to the system 200 of FIG. 2, it is to be appreciated that they are identified for purposes of providing a detailed example of the manner in which operating code can be provided to a network device. Therefore, the scope of the present disclosure is not intended to be limited to this implementation only. Persons having ordinary skill in the art will readily appreciate the many other implementations that are feasible from the concepts discussed in the present disclosure.

As indicated in FIG. 2, the system 200 can comprise one or more network printers 202 and one or more network servers 204. In the example arrangement shown in FIG. 2, each of the network printers 202 is connected to a local area network (LAN) 206. By way of example, the LAN 206 can comprise a home or office network in which connections are made through actual, physical connections or wirelessly. In the former case, connectivity may be facilitated through a hard-wired network using a common protocols such as Ethernet, or through a shared system such as a telephone and/or powerline network. In the wireless context, connectivity may be facilitated with a wireless networking protocol such as Bluetooth™ from Bluetooth SIG™ or 802.22 protocol from the Institute of Electrical and Electronics Engineers (IEEE). As will be appreciated from the discussion that follows, the precise configuration and protocol used to form the LAN 206 are not critical. More important is that the LAN 206 is configured to facilitate communications between the various components that are connected to the LAN.

In addition to the various network printers 202, also connected to the LAN 206 is a network server 204. As is described in greater detail below, the network server 204 is capable of storing various code (software and/or firmware) that can be shared with the network printers 202 during booting. Although only one such server is shown in FIG. 2, it will be appreciated that two or more servers could be connect to the LAN 206 and therefore used as sources of code.

The LAN 206 is in communication with a wide area network (WAN) 208 that, for instance, may comprise part of the Internet. Connected to the WAN 208 are network (e.g., web) servers 210. Like the LAN server 204, the network servers 210 can store various code that, as discussed below, can be shared with the network printers 202 as needed. Although three such servers 210 are depicted, it will be understood that these servers are representative of the many servers that may be accessible over the WAN 208.

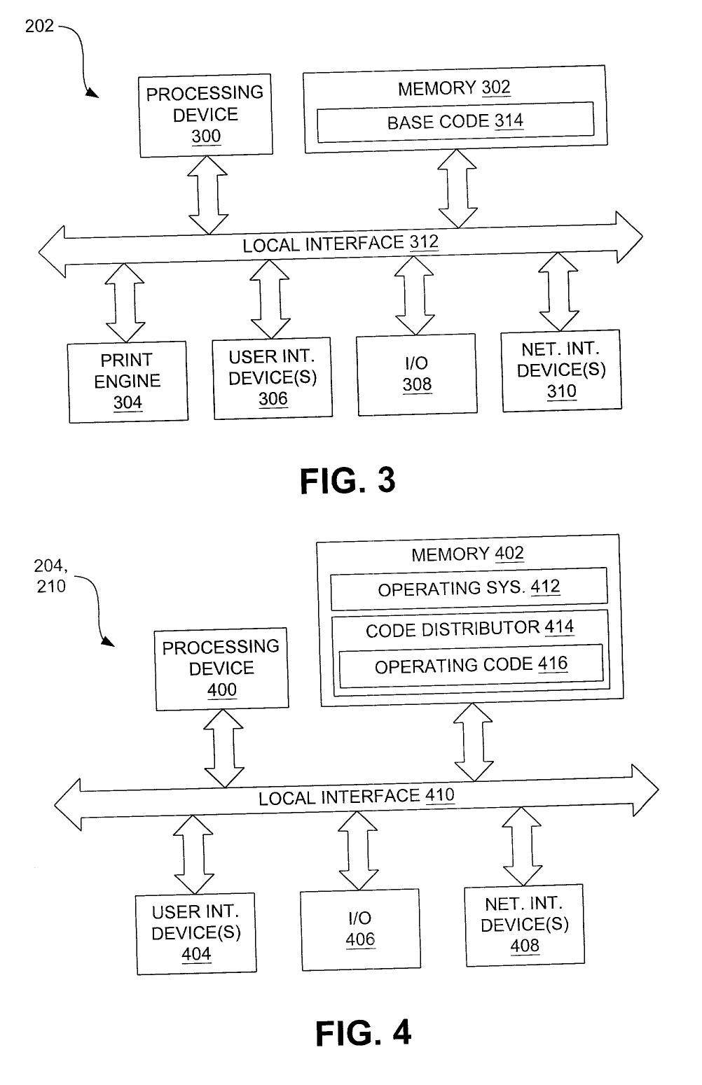

FIG. 3 is a block diagram of an example architecture for the network printers 202 shown in FIG. 2. As indicated in FIG. 3, each network printer 202 can, for instance, comprise a processing device 300, memory 302, a print engine 304, one or more user interface devices 306, one or more input/output (I/O) devices 308, and one or more network interface devices 310, each of which is connected to a local interface 312 that can comprise one or more internal and/or external buses. The processing device 300 can include any custom made or commercially available processor, a central processing unit (CPU) or an auxiliary processor among several processors associated with the network printer 202, a semiconductor based microprocessor (in the form of a microchip), or a macroprocessor. The memory 302 can include any one of a combination of volatile memory elements (e.g., RAM, such as DRAM, SRAM, etc.) and nonvolatile memory elements (e.g., ROM, hard disk, tape, CDROM, etc.).

The print engine 304 comprises the various components that are used to apply toner or ink to a print medium, such as paper. The one or more user interface devices 306 comprise those components with which the user can interact with the network printer 202. By way of example, these components can comprise one or more buttons, a display, etc. Where a display is provided, it may comprise, for instance, a touch-sensitive liquid crystal display (LCD).

With further reference to FIG. 3, the one or more I/O devices 308, are adapted to facilitate connection of the network printer 202 to another device and may therefore include one or more serial, parallel, small computer system interface (SCSI), universal serial bus (USB), IEEE 1394 (e.g., Firewire™), and/or personal area network (PAN) components. The network interface devices 310 comprise the various components used to transmit and/or receive data over a network (e.g., LAN 206). By way of example, the network interface devices 310 include a device that can communicate both inputs and outputs, for instance, a network card, modulator/demodulator (e.g., modem), wireless (e.g., radio frequency (RF)) transceiver, a telephonic interface, a bridge, a router, etc.

The memory 302 comprises base code 314 that provides just enough intelligence to the network printer 202 such that connection can be made with a suitable code source such as a network server 204 or 210. Accordingly, as used herein, the term “base code” excludes the normal operating code upon which the network printer (or other network device) relies to carry out its normal operation (e.g., printing). This base code 314 is normally stored in some non-volatile memory such as ROM or an internal hard disk, depending upon the particular configuration of the network printer 202. Although other code can, optionally, be stored in memory 304, such code may not be stored locally to both reduce the amount of storage space that is required (to reduce the cost of the device), and to permit simplified updating of the device operating code. Alternatively, however, the memory 304 could include an original operating code copy as a backup precaution in case a connection cannot be made with an appropriate code source.

FIG. 4 is a block diagram that illustrates an example architecture for the network servers 204, 210 shown in FIG. 2. As indicated in FIG. 4, each network server 204, 210 can, for example, comprise a processing device 400, memory 402, user interface devices 404, one or more I/O devices 406, and network interface devices 408, each of which is connected to a local interface 410 that comprises one or more internal and/or external buses.

The processing device 400 comprises hardware for executing software that is stored in memory 402. The processing device 400, like processing device 300 of the printer 202, can include any custom made or commercially available processor, a central processing unit (CPU) or an auxiliary processor among several processors associated with the network server 204, 210, a semiconductor based microprocessor (in the form of a microchip), or a macroprocessor. In addition, the memory 402 can, like memory 302, also include any one of combination of volatile memory elements and nonvolatile memory elements. Note that the memory 402 can have a distributed architecture, where various components are situated remote from one another, but accessible by the processing device 400.

The user interface devices 404 normally comprise those components that are typically used in association with a server or personal computer (PC) including, for instance, a keyboard, mouse, and monitor (or other display). The I/O devices 406 and the network interface devices 408 provide the same general functionality of the like-named components of the network printer 202 and, therefore, may have similar configurations.

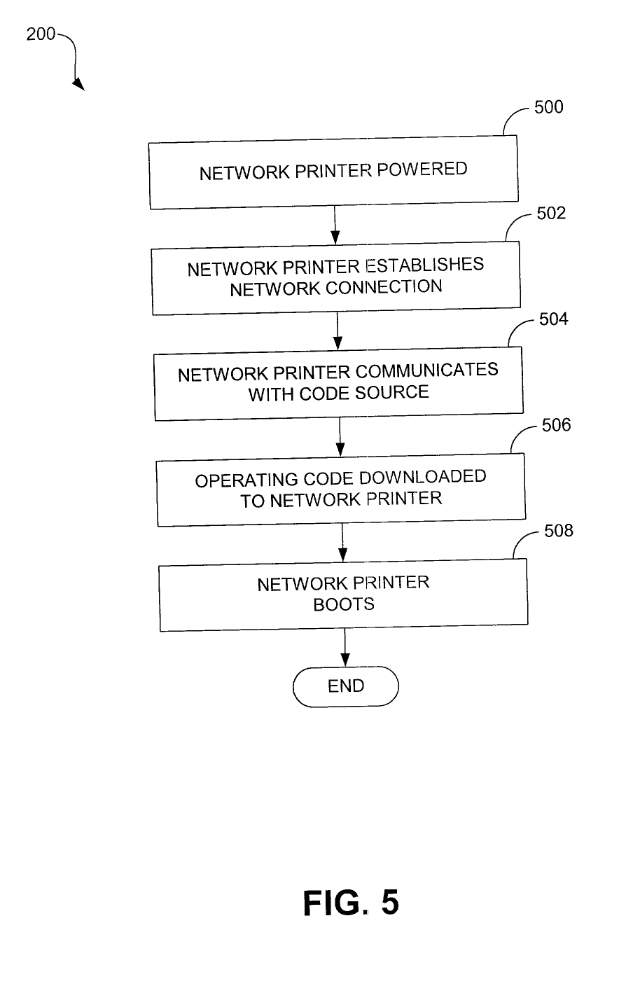

The memory 402 comprises various software including an operating system (O/S) 412 that controls the execution of other software and provides scheduling, input-output control, file and data management, memory management, and communication control and related services. In addition, the memory 402 stores, e.g., in ROM or in one or more hard disks, a code distributor 414 that, as is described in greater detail below with reference to FIGS. 5-7, is used to distribute printer operating code 416 to the one or more network printers 202.

Various code (software and/or firmware) has been described herein. It is to be understood that this code can be stored on any computer readable-medium for use by or in connection with any computer-related system or method. In the context of this document, a computer-readable medium is an electronic, magnetic, optical, or other physical device or means that can contain or store a computer program for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As described above, there are drawbacks associated with having all operating code of a network device, e.g., network printer 202, residing within the device, itself. To avoid these drawbacks, the network device can instead be configured to automatically acquire this operating code from a separate code source. With such an operating scheme, the network device can boot with the aid of the code source, thereby permitting simplification of the device design in terms of storage componentry and thereby permitting the network device, or a group of such devices, to have the most current operating code available.

FIG. 5 provides an example of operation of the system 200 shown in FIG. 2 in providing operating code to a network printer 202. Beginning with block 500, the network printer 202 is powered by, for instance, activating a power button of the user interface device(s) 306. Once powered, the network printer 202 establishes a connection with a network, for instance LAN 206 and/or WAN 208, as indicated in block 502. Next, with reference to block 504, the network printer 202 communicates with a code source, for example network server 204 or 210.

Once communications are established between the network printer 202 and the network server 204, 210, operating code is downloaded to the printer from the server, as indicated in block 506. Optionally, appropriate validation could be performed to ensure that the network printer 202 is authorized to download code. Generally speaking, the operating code comprises the an operating system (O/S) that controls all printer functions including translation of data, rasterizing, operation of the print engine 304, etc. With this O/S, the network printer can boot, as indicated in block 508. At this point, the network printer 202 is available for general use.

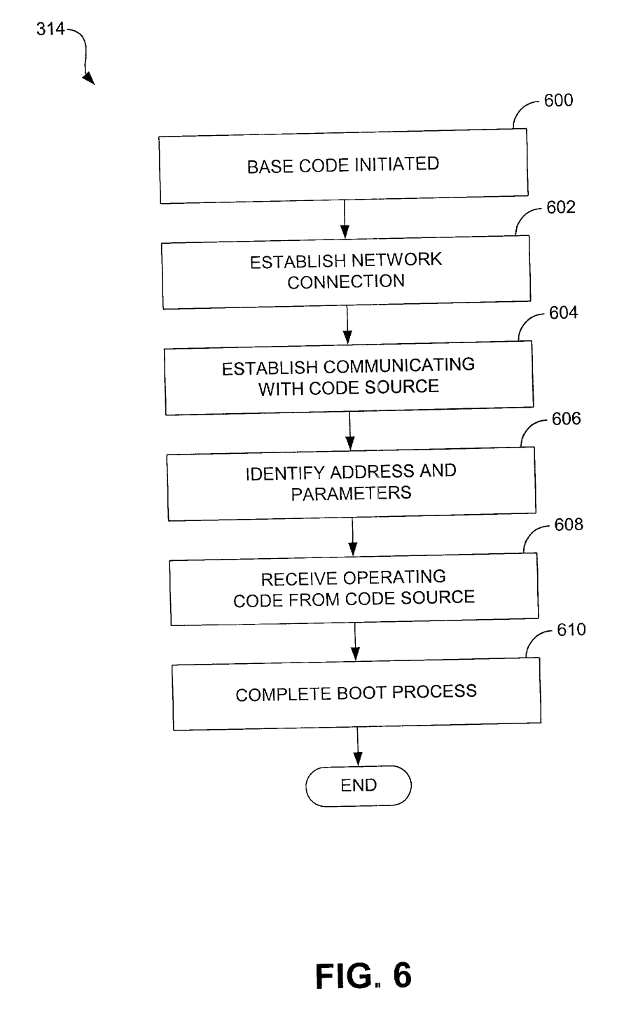

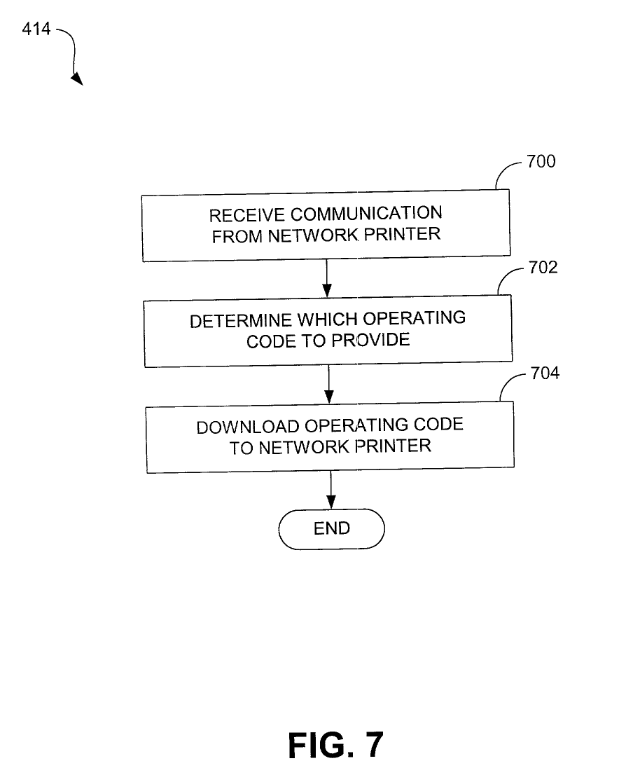

Reference is now made to FIGS. 6 and 7, which illustrate operation of the base code 314 of the network printer 202 and the code distributor 414 of the network server 202, 210, respectively. Beginning with block 600 of FIG. 6, the base code 314 of the network printer 202 is initiated. As identified above with reference to FIG. 5, this initiation can occur in response to the network printer 202 being powered. Alternatively, however, initiation can occur in response to a reboot command that, for instance, is entered directly into the network printer 202 by selecting an appropriate button or key of the user interface device(s) 306. Such a reboot command can also be registered by accessing a network page served by the network printer 202 where the printer includes an embedded server (not shown).

Once the base code 314 is initiated, the code establishes a network connection, as indicated in block 602, through the network interface devices 310. By way of example, this connection links the network printer 202 to the LAN 206 and, potentially, to the WAN 208. Notably, if it is not possible to establish such a connection, the network printer 202 can, if provided with a resident copy of the operating code, load the local version of the operating code to enable use of the printer until such time when a network connection can be established. Assuming a network connection is made, the network printer 202 communicates with an operation code source, as indicated in block 604. As noted above, this source can comprise either a local server 204 on the LAN 206, or a remote server 210 on the WAN 210. In the latter case, the server 210 may comprise a web server that is accessible over the Internet using an appropriate universal resource locator (URL).

Through this communication, the base code 314 can identify the address and parameters of the network printer 202 (e.g., make, model, hardware capabilities, etc.) to the server 204, 210 as indicated in block 606. Referring now to FIG. 7, the code distributor 414, as indicated in block 700, first receives the communication from the network printer 202 (which contains the address and information) so that the distributor can determine what operating code 416 to provide to the network printer, as indicated in block 702. Generally speaking, this determination may comprise comparing the parameter information received by the network printer 202 with information contained in an appropriate look-up table that is stored in server memory 402. Typically, the operating code is up-to-date so that the most current versions of operating code can be provided to the network printers 202. Once the determination as to what code is to be provided to the requesting printer(s) 202 has been made, the code distributor 414 facilitates downloading of operating code 416 to the printer(s), as indicated in block 704.

Returning to FIG. 6 and block 608, the base code 314, or more generally the network printer 202, receives the applicable operating code which, as noted above, typically comprises an O/S. With this operating code, the printer 202 can then complete the booting process, as indicated in block 610. After booting is complete, the network printer 202 is ready for use. Assuming the operating code 416 stored in the server 204, 210 is current, booting of the network printer 202 (or other network device) in this manner will ensure that the printer, and any other printer booted in the same manner, has the most up-to-date operating code. Moreover, in that a substantial portion of the code is obtained from the server 204, 210, the printer 202 (or other network device) will require less ROM and/or hard disk space, thereby reducing its cost.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for booting, comprising:
establishing a network connection;
communicating with a code source via the network;
downloading operating code from the code source via the network; and
booting using the downloaded operating code.

2. The method of claim 1, wherein the step of establishing a network connection comprises establishing a network connection using locally stored base code.

3. The method of claim 1, wherein the step of communicating with a code source comprises identifying an address and device parameters to the code source.

4. The method of claim 1, wherein the step of downloading operating code comprises downloading operating code from a network server.

5. The method of claim 1, wherein the step of downloading operating code comprises downloading an operating system.

6. A method for facilitating booting of a network device, comprising:
receiving a communication from the network device requesting operating code;
determining which operating code to provide to the network device; and
downloading operating code to the network device via the network.

7. The method of claim 6, wherein the step of receiving a communication comprises receiving a device address and a device parameter.

8. The method of claim 6, wherein the step of downloading operating code comprises downloading an operating system to the network device.

9. The method of claim 6, wherein the network device is a network printer.

10. A system for booting, comprising:
means for establishing a network connection;
means for communicating with a code source via the network;
means for downloading operating code from the code source via the network; and
means for booting using the downloaded operating code.

11. The system of claim 10, wherein the means for establishing a network connection comprise locally stored base code.

12. A system for facilitating booting of a network device, comprising:
means for receiving a communication from the network device requesting operating code;
means for determining which operating code to provide to the network device; and
means for downloading operating code to the network device via the network.

13. The system of claim 12, wherein the means for downloading operating code comprise a code distributor.

14. A network printer, comprising:
a processing device;
a network interface device; and
non-volatile memory including base code that is configured to establish a network connection and communicate with a code source via the network to prompt the network source to download operating code to the network printer.

15. The printer of claim 14, wherein the non-volatile memory does not store printer operating code.

16. The printer of claim 14, wherein the non-volatile memory comprises a read-only memory (ROM) device.

17. The printer of claim 14, wherein the non-volatile memory comprises an internal hard disk.

18. A network server, comprising:
a processing device;
a network interface device; and
memory including an operating system and a code distributor that is configured to download operating code to a requesting network device that is used by the network device to boot.

19. The server of claim 18, wherein the operating code comprises operating code for a network printer.

20. The server of claim 19, wherein the printer operating code comprises a printer operating system.
